(19) United States
(12) Patent Application Publication
(10) Pub. No.: US 2023/0113969 A1
(43) Pub. Date: Apr. 13, 2023

(54) WHEEL ASSEMBLY FOR SCREENING MACHINE

(71) Applicant: SANDVIK SRP AB, Svedala (SE)

(72) Inventor: Sami NURMINEN, Lahti (FI)

(21) Appl. No.: 17/796,169

(22) PCT Filed: Jan. 29, 2020
(86) PCT No.: PCT/EP2020/052080

§ 371 Date: Jul. 28, 2022

(51) Int. Cl. B06B 1/16; B07B 1/44

(52) U.S. Cl. CPC B06B 1/168; B07B 1/44

(57) ABSTRACT

A wheel assembly for a shaft of a screening machine includes a disc and a first and a second weight unit. The first and the second weight units are arranged such that the disc is in equilibrium along a longitudinal axis passing through the center of the disc and the longitudinal axis is perpendicular to a diametrical extension of the disc. A screening machine having the wheel assembly is also provided.

### FIELD OF INVENTION

The present invention relates to a screening machine that has a housing to which at least one screen is attached. Screening machines are used in order to sort bulk material and solid material, such as stones and similar.

### BACKGROUND

There are different types of screening machines and different applications thereof within the mining and construction industry. Linear motion screening machines and circular motion screening machines use two slightly different principles in order to sort the material to be sorted. Both types of screening machines use a shaft passing through the housing of the machine and being parallel with the screen. The number of screens is typically one to four, normally a higher number for circular motion screening machines. The arrangement of the shaft is in the centre of mass of the machine or close to the centre depending on the structure of the machine. In connection to the shaft a wheel assembly is arranged in order to create an oscillating motion for the screen(s).

DE 20 2008 003 553 discloses an examplary screening apparatus for classifying stones and solid materials by vibrations on the screening decks. The number of screening decks is three. The vibration of the machine is caused by a motor arranged in connection to the housing of the screening apparatus. In order to cause different moments of inertia with an oscillating behavior of the screening decks, a flywheel is arranged on a shaft passing through the housing. The flywheel has replaceable components. However, the replaceable components are only arranged on one side of the flywheel's base plate. This leads to a screening apparatus needing robust flanges on the inside of the side walls for properly supporting the shaft and hindering deflection of the shaft. The flywheel is also limited in how the weights can be arranged and the number of weight elements that can be arranged on the flywheel.

Thus, what is required is a wheel assembly that addresses the above problems.

### SUMMARY

It is an object of the present invention to provide an improved imbalance wheel assembly for a screening machine. The present wheel assembly has more flexibility in the arrangement of the weights and minimizes deflection of the shaft.

According to a first aspect of the present invention, there is provided a wheel assembly for a shaft of a screening machine, wherein the wheel assembly comprises a disc and a first and a second weight unit, and wherein the first and the second weight units are arranged such that the disc is in equilibrium of weight along a longitudinal axis passing through the centre of the disc and the longitudinal axis is perpendicular to the diametrical extension of the disc. This is important in order to make sure that the wheel assembly can be appropriately arranged on the shaft and deflection of the shaft can be avoided. If the shaft is deflected, the life time of the bearings is reduced, which bearings are arranged inside of the wheel assembly. The shaft might also break or there could be oil leakages since the sealings no longer are in close contact with the shaft surface due to bending of the shaft.

The wheel assembly with the first weight unit can be arranged on a first side of the disc and the second weight unit arranged on a second side of the disc. Thereby, a wide range adjustable and symmetric imbalance wheel is achieved. Additionally, a smaller sized motor can be used since a wheel assembly in equilibrium is easier to rotate and thus requires less power. Alternatively, using a motor of normal size makes it possible to create oscillating movements of larger screens and larger screening machines.

Optionally, the wheel assembly can have both weight units having corresponding shapes, such that they are symmetrically arranged on both sides of the disc, and that the weight units are arranged at the same radial distance from the centre of the disc and at the same location in relation to the perimeter of the disc on both sides of the disc. By unifying the shape of the weight units a simplified manufacturing process can be used.

Optionally, the wheel assembly may have a disc that comprises a first disc part defining one half turn of the disc seen from its centre point in rotational direction and a second disc part defining the other half turn of the disc in rotational direction, wherein both weight units are arranged on the first disc part. This arrangement gives an efficient use of the space. It also achieves an optimal imbalance moment with an eccentric movement of the wheel assembly.

The wheel assembly's weight units may cover 175° in rotational direction on the first part of the disc. This achieves an optimized arrangement of the weight units, i.e., as much weight as possible to get a high centre of gravity.

Optionally, the wheel assembly's weight units have an inner and outer radius defining the location of the weight unit on the disc in radial direction. This provides a rounded shape of the weight units, which achieves a smooth rotational movement.

The wheel assembly may have a disc that has a varying radius, and wherein the radius of the first disc part is approximately the same as the radius of the second disc part. This gives a symmetrically shaped disc that achieves an appropriate momentum.

The wheel assembly with the shape of the disc has a varying radius, and wherein the radius of the first disc part is larger than the radius of the second disc part. This gives good imbalance properties.

Optionally the wheel assembly has a radius of the first disc part that is smaller than the outer radius of the weight unit. This is an efficient use of the placement of the weight units on the first disc part.

The wheel assembly may have a radius of the second disc part that is approximately the same as the inner radius of the weight unit. This results in an optimal space requirement with a placement of the weight unit to achieve an appropriate momentum.

Optionally, the wheel assembly's weight units comprise a plurality of elements. By this arrangement a variable size of the weight unit can be achieved.

The wheel assembly with the weight unit elements can be arranged axially on the disc. This gives a slim and optimal arrangement of weight units on the disc.

Optionally, the wheel assembly's weight elements comprise first elements having a first thickness in axial direction and second elements having a second thickness in axial direction. This results in a high number of options to build up the weight units.

The wheel assembly's weight elements may be joined together by screws or other fastening elements, so there is a tight fit together of the elements.

Optionally, the wheel assembly's weight elements are joined together by pins. This gives additional stabilisation and support.

Optionally, the wheel assembly's arrangement of screws is a number of three evenly distributed in rotational direction with two pins evenly distributed between the screws.

This gives the arrangement an optimal support and tightening.

According to a second aspect of the present invention there is provided a screening machine comprising a wheel assembly for a shaft.

### BRIEF DESCRIPTION OF DRAWINGS

A specific implementation of the present invention will now be described by way of example only and with reference to the following drawings in which:

FIG. 1 is a perspective view of a screening machine;

FIG. 2A is a side view of a first embodiment of a wheel assembly;

FIG. 2B is a perspective view of the first embodiment of the wheel assembly;

FIG. 3A is a side view of a second embodiment of a wheel assembly;

FIG. 3B is a perspective view of the second embodiment of the wheel assembly.

### DETAILED DESCRIPTION

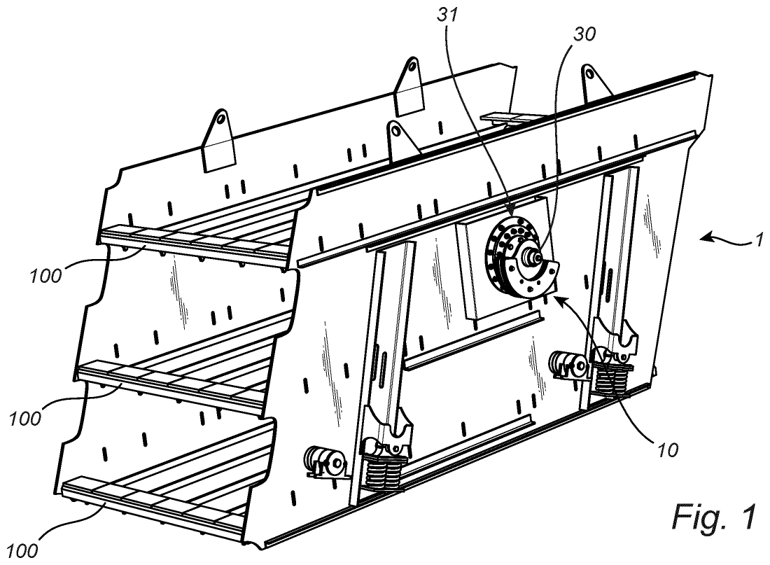

FIG. 1 discloses a screening machine 1. In the machine three screens 100 are arranged.

The number of screens can vary depending on the type of the machine. The type represented in this figure is a so called circular motion screening machine, which has three screens. This type of screening machine normally has a number of screens from two to four. Another type is a linear motion screening machine, which normally has a somewhat smaller number of screens, such as one to three. Screens can also be referred to as screening decks.

In order for the screening machine to vibrate and/or oscillate a wheel assembly 10 is arranged on one side of the screening machine. The wheel assembly 10 is mounted around a shaft 30. Between the wheel assembly and the side wall of the screening machine there is normally a number of distance elements 31 arranged. These distance elements are also arranged around the shaft. A wheel assembly might also be referred to as a flywheel. The shaft 30 is arranged through the screening machine, preferably near the center of mass of the machine. Arranged on the shaft are bearings, which are arranged on the inside of the screening machine. The wheel assembly is normally sheltered inside a cover (not shown in the figures). The cover is needed for safety reasons.

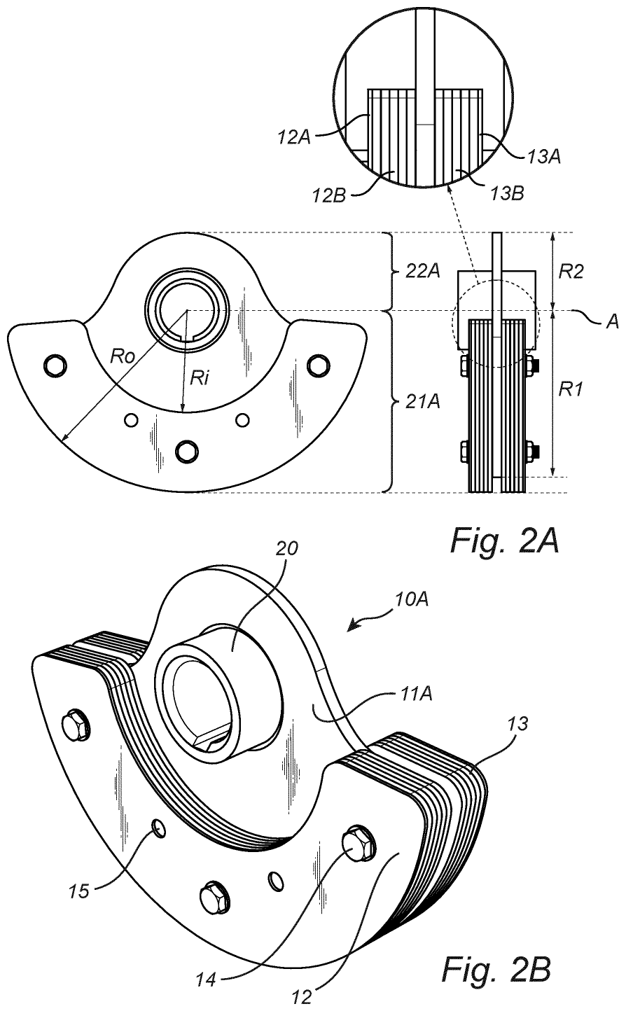

FIGS. 2A and 2B disclose a first embodiment of a wheel assembly 10A. A disc 11A is arranged around a shaft connection 20. The diametrical extension of the disc 11A is perpendicular to the axis of the shaft 30. The disc has an asymmetrical shape such that approximately one half of the disc has a larger radius R1 and the other half of the disc has a smaller radius R2, with two transitional sections in between the two halves where the radius transits from the larger to the smaller radius with a smooth transition between the differently sized halves. The first half with the larger radius is called a first part 21A and the second half with the smaller radius is called a second part 22A. In all figures all radii have an origin and starting point coinciding with the center of the shaft. The diametrical extension of the disc 11A is defined as R1+R2.

On the first part 21A weight units 12, 13 are arranged. The weight units are symmetrically arranged on both sides of the disc 11A. The first side weight units comprise a number of thicker weight elements 12B and thinner weight elements 12A. Normally, the thinner weight elements are arranged outermost, but it might also be the other way around, so that the thinner weight elements are the innermost. The thinner elements have normally half of the thickness as the thicker elements. In the figures an exemplary embodiment shows a number of five thicker weight elements 12B, 13B arranged on each side respectively and one thinner weight element 12A, 13A arranged on each side respectively. The number of thinner and thicker weight elements may vary, but is always the same on the first and second side of the disc. So that the disc 11A is in equilibrium of weight along a longitudinal axis A passing through the centre of the disc and the longitudinal axis A is perpendicular to the diametrical extension of the disc. Also the longitudinal axis is the same as the center of the shaft 30.

The weight elements are arranged and attached with help of screws 14 and pins 15, which might be evenly distributed on the disc and the weight units. As is disclosed in the figures the pins 15 may be mounted on a shorter radial distance and the screws 14 on a somewhat larger radial distance, but they may also be differently arranged so that the pins are arranged further out from the center than the screws. The number of screws is preferably three, but could also be two or four. The number of pins is preferably two, but could also be three or four. The pins 15 are mounted in holes and the end surface of the pins is sunken in the respective hole such that there is no part of the pin reaching outside of the weight units 12, 13.

The weight units 12, 13 are arranged on the outermost first part 21A of the disc 11A. The weight units have an arc shape with an outer radius Ro and an inner radius Ri defining the extent and placement on the disc 11A of the weight units. The outer radius Ro is somewhat larger than the radius R1 of the disc's first part 21A. The inner radius Ri is approximately half of the outer radius Ro. The inner radius Ri might also be 40% or 60% of the outer radius Ro. The weight units cover nearly half a circle (180°), for example, 175°. The extent could also be somewhat smaller such as 170°, 160° or 150°. Both ends of the arc have a straight edge with rounded corners. The ends could also have a more rounded shape.

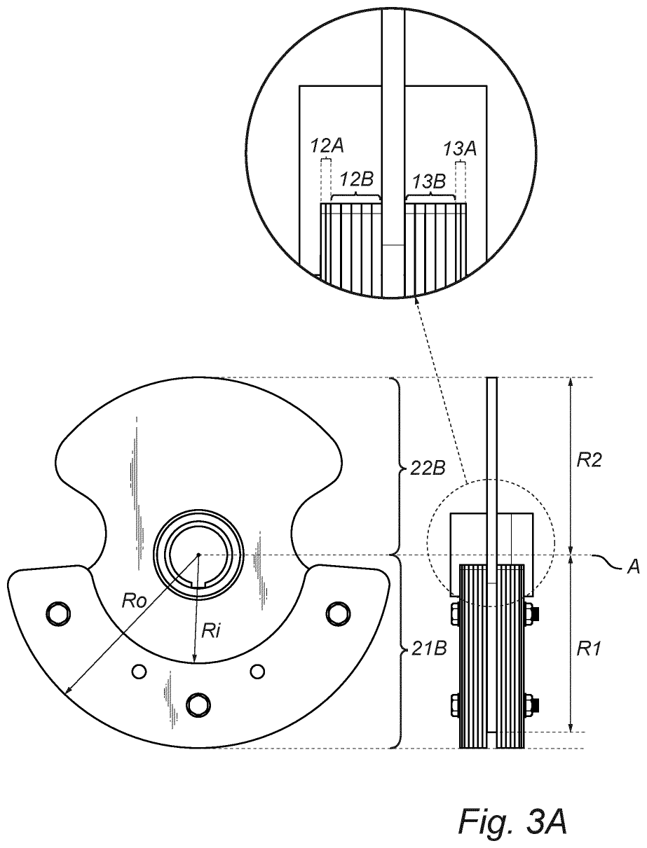

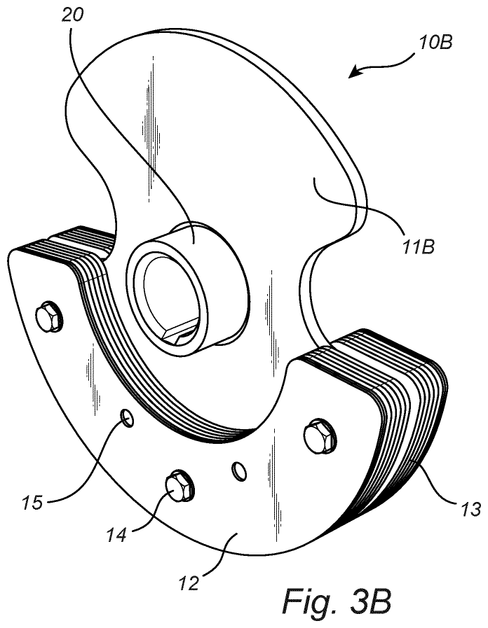

FIGS. 3A and 3B disclose a second embodiment of a wheel assembly 10B. A disc 11B is arranged around a shaft connection 20. Similar to the first embodiment of the wheel assembly, the diametrical extension of the disc 11B is perpendicular to the axis of the shaft 30. The disc 11B of the second embodiment is a round disc with two indentations comprising a first part 21B with a first radius R1 and a second part 22B with a second radius R2, where the first radius R1 equals the second radius R2. The two indentations are arranged diametrically opposite to each other, so that the indentations divide the disc into the first part 21B and the second part 22B, respectively. Thus, the first part 21B defines nearly a first half of the disc and the second part 22B defines nearly a second half of the disc. The two indentations have rounded shape so they make a smooth transition between the first and the second part. The first part 21B and the second part 22B have an identical shape, so the halves are symmetrically mirrored. Similar to the first embodiment of the wheel assembly, the disc 11B has the diametrical extension R1+R2.

The second embodiment of the wheel assembly comprises a larger disc than the first embodiment of the wheel assembly. The second embodiment achieves a lower imbalance and thus, greater oscillating movement of the screening machine 1 and the screens 100.

On the first part 21B weight units 12, 13 are arranged. As in the first embodiment, the weight units are symmetrically arranged on both sides of the disc 11B. The first side weight units comprise a number of thicker weight elements 12B and thinner weight elements 12A. Normally the thinner weight elements are arranged outermost, but it might also be the other way around, so that the thinner weight elements are the innermost. The thinner elements have normally half of the thickness than the thicker elements. In the figures an exemplary embodiment shows a number of five thicker weight elements 12B, 13B arranged on each side respectively and two thinner weight elements 12A, 13A arranged on each side respectively. As with the first embodiment, the number of thinner and thicker weight elements may vary, but is always the same on the first and second side of the disc. Similar to the first embodiment the disc 11B is in equilibrium of weight along a longitudinal axis A passing through the centre of the disc and the longitudinal axis A is perpendicular to the diametrical extension of the disc. Also the longitudinal axis is the same as the center of the shaft 30.

The weight elements are arranged and attached with help of screws 14 and pins 15, which might be evenly distributed on the disc and the weight units. The arrangement of the screws and the pins is made accordingly as in relation to the first embodiment.

Just as with the first embodiment, the weight units 12, 13 are arranged on the outermost first part 21B of the disc 11B. The weight units have an arc shape with an outer radius Ro and an inner radius Ri defining the extent and placement on the disc 11B of the weight units. The outer radius Ro is somewhat larger than the radius R1 of the disc's first part 21B. The weight units follow the same characteristics as with the first embodiment.

1. A wheel assembly for a shaft of a screening machine, the wheel assembly comprising:
a disc and
a first and a second weight unit, and wherein the first and the second weight units are arranged such that the disc is in equilibrium of weight along a longitudinal axis passing through the centre of the disc and the longitudinal axis is perpendicular to a diametrical extension of the disc.

2. The wheel assembly as claimed in claim 1, wherein the first weight unit is arranged on a first side of the disc and the second weight unit is arranged on a second side of the disc.

3. The wheel assembly as claimed in claim 1, wherein both the first and second weight units have corresponding shapes such that the first and second weight units are symmetrically arranged on both sides of the disc, and that the first and second weight units are arranged at the same radial distance from the centre of the disc and at a same location in relation to a perimeter of the disc on both sides of the disc.

4. The wheel assembly as claimed in claim 1, wherein the disc comprises includes a first disc part defining one half turn of the disc as seen from its centre point in a rotational direction and a second disc part defining a other half turn of the disc in the rotational direction, and wherein both first and second weight units are arranged on the first disc part.

5. The wheel assembly as claimed in claim 1, wherein the first and second weight units cover 175° in the rotational direction on the first part of the disc.

6. The wheel assembly as claimed in claim 1, wherein the first and second weight units have an inner and outer radius defining a location of each weight unit on the disc in a radial direction.

7. The wheel assembly as claimed in claim 4, wherein the disc has a varying radius, and wherein a radius of the first disc part is approximately the same as a radius of the second disc part.

8. The wheel assembly as claimed in claim 4, wherein the shape of the disc has a varying radius, and wherein a radius of the first disc part is larger than a radius of the second disc part.

9. The wheel assembly as claimed in claim 4, wherein a radius of the first disc part is smaller than an outer radius of the first and second weight units.

10. The wheel assembly as claimed in claim 4, wherein a radius of the second disc part is approximately the same as an inner radius of the first and second weight units.

11. The wheel assembly as claimed in claim 1, wherein the first and second weight units comprise include a plurality of weight unit elements.

12. The wheel assembly as claimed in claim 11, wherein the weight unit elements are arranged axially on the disc.

13. The wheel assembly as claimed in claim 11, wherein the weight unit elements comprising include first elements having a first thickness in axial direction and second elements having a second thickness in the axial direction.

14. The wheel assembly as claimed in claim 11, wherein the weight unit elements are joined together by screws.

15. The wheel assembly as claimed in claim 11, wherein the unit weight elements are joined together by pins.

16. The wheel assembly as claimed in claim 14, wherein an arrangement of the screws is a number of three evenly distributed in a rotational direction with two pins being evenly distributed between the screws.

17. A screening machine comprising a wheel assembly according to claim 1.
